(19) United States
(12) Patent Application Publication
(10) Pub. No.: US 2006/0147668 A1
(43) Pub. Date: Jul. 6, 2006

(54) Label sheet

(76) Inventors: Kenji Hirose, Kasugai-shi (JP); Kayoko Hayashi, Nagoya-shi (JP); Mariko Ueki, Kasugai-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/316,846

(22) Filed: Dec. 27, 2005

(30) Foreign Application Priority Data
Jan. 5, 2005 (JP) 2005-000716

(51) Int. Cl. G09F 3/00

(52) U.S. Cl. 428/42.3; 428/43

(57) ABSTRACT

A unit label on a first tier is connected to a unit label on a second tier by a connecting portion in a vicinity of the lower right corner portion of the first tier unit label. The strength of the connecting portion is set so that the connecting portion is separated when a corner portion of the second tier unit label is in a raised state following the first tier unit label being peeled from a release sheet. Thereby, a start portion from which subsequent unit labels can be peeled off from the release sheet can be easily made. As a result, the subsequent unit labels are easily removed from a release sheet.

### BACKGROUND OF THE INVENTION

1. Field of the Invention

The present invention relates to a label sheet including a plurality of unit labels.

2. Description of the Prior Art

Conventionally, regarding label sheets, there is a known sheet in which a release sheet is applied on an information-indicating sheet having an adhesive layer. The release sheet is applied so as to cover the adhesive layer. Several cut lines forming a closed loop shape are formed on the information-indicating sheet to allow a plurality of labels (hereinafter, also referred to as unit labels) to be individually separated (see Japanese Patent Laid-open No. 9-48188).

In order to peel a unit label from such a label sheet and apply it, for example, to an envelope or the like, only a corner portion of the unit label is initially raised from the release sheet. The corner portion of the label is picked up with fingers and pulled, whereby the label is peeled from the release sheet.

However, when a label is to be peeled off, it is sometimes difficult to raise the corner portion of the label from the release sheet. It is sometimes also difficult to make a starting portion from which the label can be peeled off.

The present invention is completed based on the above described circumstances and has as an object to provide a label sheet in which a starting portion, from which a label may be peeled from the release sheet, can be easily made and the label is therefore easily peeled off.

### SUMMARY OF THE INVENTION

As the means for achieving the above-described object, in the present invention there is a label sheet having an information-indicating sheet containing an adhesive layer, and a release sheet, which is applied to the adhesive layer. A plurality of substantially rectangular unit labels are made separable by forming cut lines on the above described information indicating sheet. The above described unit labels are placed and aligned in a line, and are connected to each other by connecting portions that are formed by discontinuing the cut lines in the vicinity of the common border at the corner portions of the labels. The above described connecting portion, which connects one unit label of the above described plurality of unit labels and a unit label adjacent to this one unit label, is set to have a strength with which the connecting portion is separated (i.e., broken or torn) after the corner portion of the above described adjacent unit label is in a raised state caused by the above described one unit label being peeled from the above described release sheet in such a manner as to be rolled up from the release sheet.

In this way, when the one unit label is peeled from the release sheet in such a manner as to be rolled up from the release sheet, the corner portion of the next unit label (i.e., the adjacent unit label) is pulled in a direction so as to be peeled from the release sheet by the connecting portion (i.e., at least a part of the force used to remove the one unit label is transferred to adjacent unit label). As a result, the corner portion of the next unit label is placed in a raised state. Since the connecting portion is cut or separated in this state, the raised corner portion can be picked up and peeled off when the next unit label (i.e., the adjacent unit label) is to be peeled from the release sheet. Consequently, the next unit label is easily peeled off of the release sheet.

### BRIEF DESCRIPTION OF THE DRAWINGS

FIG. 1 is a front surface view of a label sheet of a first embodiment of the present invention;

FIG. 2 is a perspective view of the label sheet of the first embodiment as seen from the front surface side during removal of a unit label;

FIG. 3 is a perspective view of the label sheet of the first embodiment as seen from the front surface side during the separation of a unit label;

FIG. 4 is a front surface view of a label sheet of a second embodiment;

FIG. 5 is a front surface view of a label sheet of a third embodiment;

FIGS. 6A and 6B are perspective views explaining an operational effect of a label sheet of the third embodiment;

FIG. 7 is a front surface view of a label sheet of a fourth embodiment;

FIG. 8 is a perspective view of the label sheet of the fourth embodiment as seen from the front surface side during removal of a unit label;

FIG. 9 is a front surface view of a label sheet of a fifth embodiment;

FIG. 10 is a back surface view of the label sheet of the fifth embodiment;

FIG. 11 is a front surface view of the label sheet of the fifth embodiment showing the operation of a tab during the removal of a unit label;

FIG. 12 is a front surface view of a label sheet of a sixth embodiment;

FIG. 13 is a perspective view of the label sheet of the sixth embodiment as seen from the front surface side during the separation of a unit label;

FIG. 14 is a front surface view of a label sheet of a seventh embodiment;

FIG. 15 is a perspective view of the label sheet of the seventh embodiment as seen from the front surface side during the separation of a unit label; and

FIG. 16 is a front surface view of a label sheet of another embodiment.

### DETAILED DESCRIPTION OF THE PREFERRED EMBODIMENTS

### First Embodiment

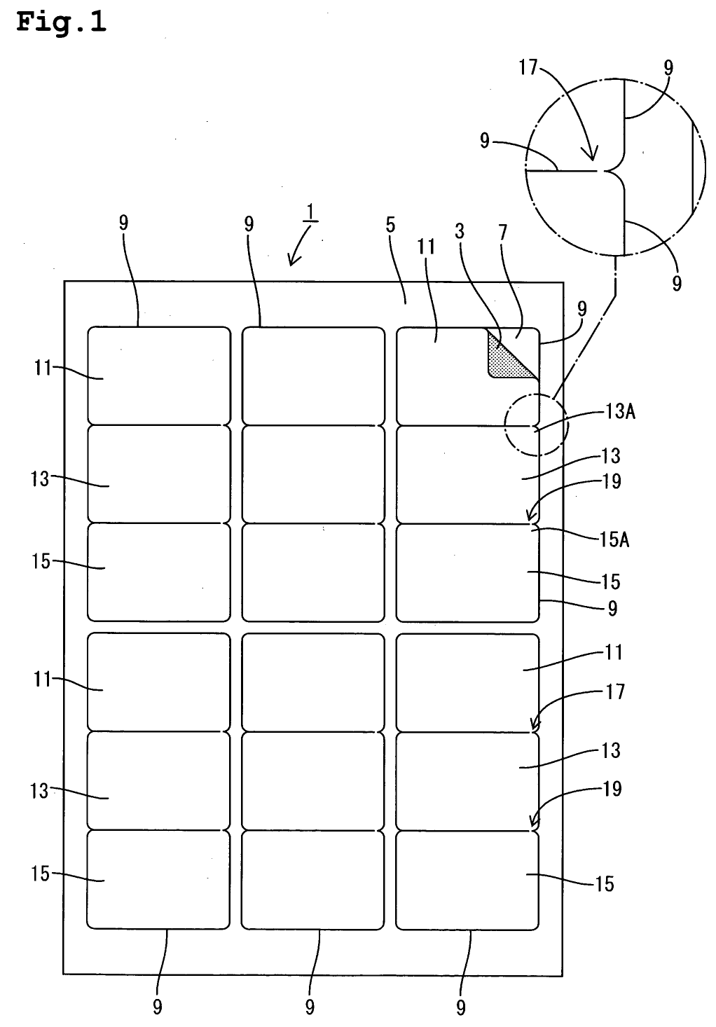

A first embodiment of the present invention will be described with reference to FIGS. 1 to 3.

A label sheet 1 of this embodiment, for example, is in an A4-sized rectangular shape and is constituted by an information-indicating sheet 5 including an adhesive layer 3, and a non-adhesive release sheet 7 removably applied to the adhesive layer 3.

A plurality of substantially rectangular (for example, the shape is not a limiting feature of the label sheet) unit labels 11, 13, and 15, are made separable by forming a corresponding plurality of substantially rectangular cut lines 9 on the information-indicating sheet 5.

The unit labels 11, 13, and 15, are placed and aligned in a line along the long side of the information-indicating sheet 5. Three unit labels 11, 13, and 15, on an upper, middle, and lower tier, constitute one set of unit labels. Six sets are shown in this example as formed on one label sheet 1.

The unit label 11 on the upper tier is connected to the unit label 13 on the middle tier by a first connecting portion 17, forming a combination of adjacent labels. The first connecting portion 17 connects both of the labels 11 and 13 via a small partially discontinuous width in the cut line 9 between the unit label 11 and the unit label 13 in the middle tier. The discontinuous section is of a form able to transfer at least a part of a force from one label to another. Examples of the discontinuity include uncut, perforated, and scored, among others. The small width is located for example in the vicinity of a lower right corner portion of the unit label 11. The unit label 13 in the middle tier is connected to the unit label 15 in the lower tier by a second connecting portion 19. The second connecting portion 19 connects both of the labels 13 and 15 with a small partially discontinuous width in the cut line 9 located in the vicinity of a lower right corner portion of the unit label 13, forming another combination of adjacent labels. Two combinations of adjacent labels are shown for each of the unit label sets in this example.

The breaking strength of the first and the second connecting portions 17 and 19 can be freely set in accordance with the material quality and the thickness dimension of the information indicating sheet 5, the width dimensions of the connecting portions 17 and 19, and the like. In this embodiment, the strength of the first connecting portion 17 is set so that when the unit label 11 on the upper tier is peeled from the release sheet 7 in such a manner as to be rolled up from the release sheet 7, the first connecting portion 17 is separated or broken after a corner portion 13A of the unit label 13 on the middle tier is also in a raised state. In order to set the connecting portion 17 to have an appropriate strength, label sheets 1 with the connecting portions 17 having various width dimensions were produced and an experiment was performed using the various width connecting portions 17. A width dimension having the optimal strength was selected based upon the results of the experiment.

Similarly, the strength of the second connecting portion 19 is also set so that when the unit label 13 on the middle tier is peeled from the release sheet 7 in such a manner as to be rolled up from the release sheet 7, the second connecting portion 19 is separated after a corner portion 15A of the unit label 15 on the lower tier is also in a raised state.

Next, a way will be described of using the label sheet 1 of this embodiment.

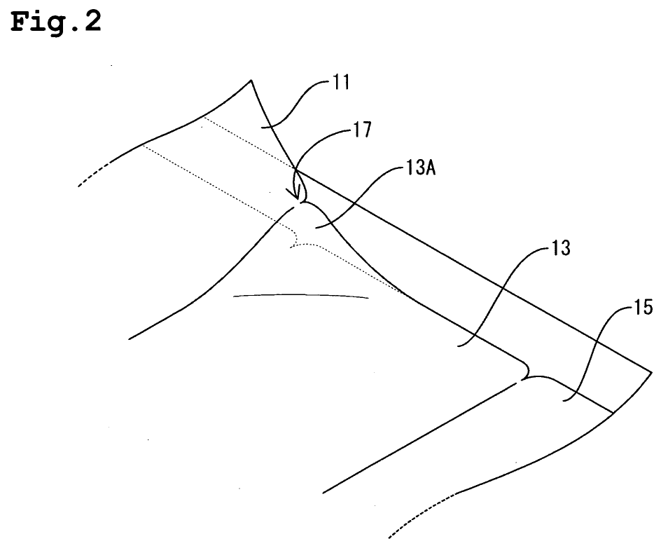

First, a printer connected to a computer, for example, prints predetermined information such as a destination address on each unit label 11 of the label sheet 1. Then, in order to apply each unit label 11, for example, to an envelope, with regard to a unit label 11 on the upper tier, as an example a corner portion at an upper right corner is first partially peeled off by engaging the upper right corner with a fingernail of a finger of a label sheet 1 user. By picking the corner up with the fingernail of the finger, the unit label 11 is peeled from the release sheet 7 in such a manner as to be rolled up from the release sheet 7, as shown in FIG. 1. Substantially when the entire unit label 11 on the upper tier is finished peeling off of the release sheet 7, the corner portion 13A of the unit label 13 in the middle tier is then pulled in a direction so as to be peeled from the release sheet 7 via the first connecting portion 17, as shown in FIG. 2. Therefore, the corner portion 13A is in a state in which it is partially raised from the release sheet 7.

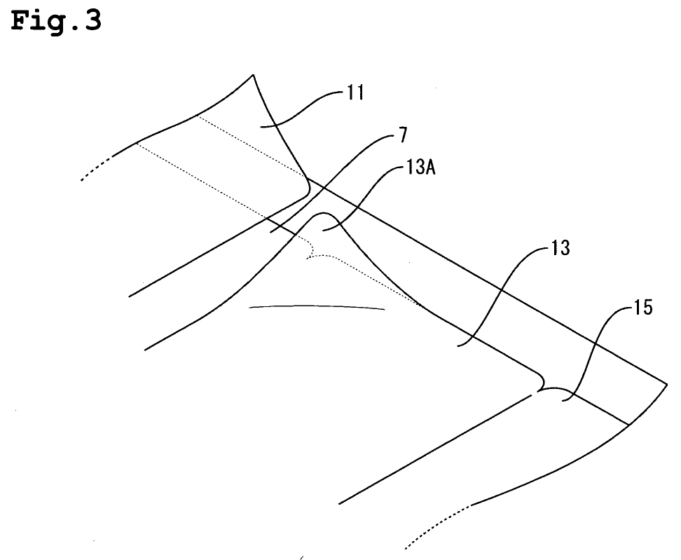

When the unit label 11 on the upper tier is further pulled so as to be separated from the release sheet 7, a resistance force acts against the peeling force due to the adhering force between the adhesive of the unit label 13 in the middle tier and the release sheet 7. Both of the forces are combined to act as a tensile force that pulls at the first connecting portion 17 with a small width from both sides. When the unit label 11 on the upper tier is raised more strongly, the first connecting portion 17 is ultimately broken as shown in FIG. 3. Consequently, only the unit label 11 on the upper tier is separated from the release sheet 7.

In this state, the corner portion 13A of the unit label 13 on the middle tier is in a condition in which it is partially raised up from the release sheet 7, and therefore easily manipulated. Thus, by picking up this corner portion 13A, the unit label 13 on the middle tier is peeled off in such a manner as to be rolled up next. After the unit label 13 on the middle tier is peeled off in a same manner as described above, the corner portion 15A of the unit label 15 on the lower tier is placed in a state in which it is naturally raised up from the release sheet 7. Therefore, when the unit label 15 on the lower tier is to be peeled off next, the unit label 15 can be easily peeled from the release sheet 7 by picking up the raised corner portion 15A.

As described above, according to the label sheet 1 of this embodiment, the corner portions 13A and 15A of the unit labels 13 and 15 are placed in the state in which they are naturally raised up in sequence from the release sheet 7 by initially peeling off the unit label 11 on the upper tier. Therefore, it is not necessary to make a starting portion from which each of the labels 13 and 15 can be peeled off, thus greatly simplifying the label removal operation.

### Second Embodiment

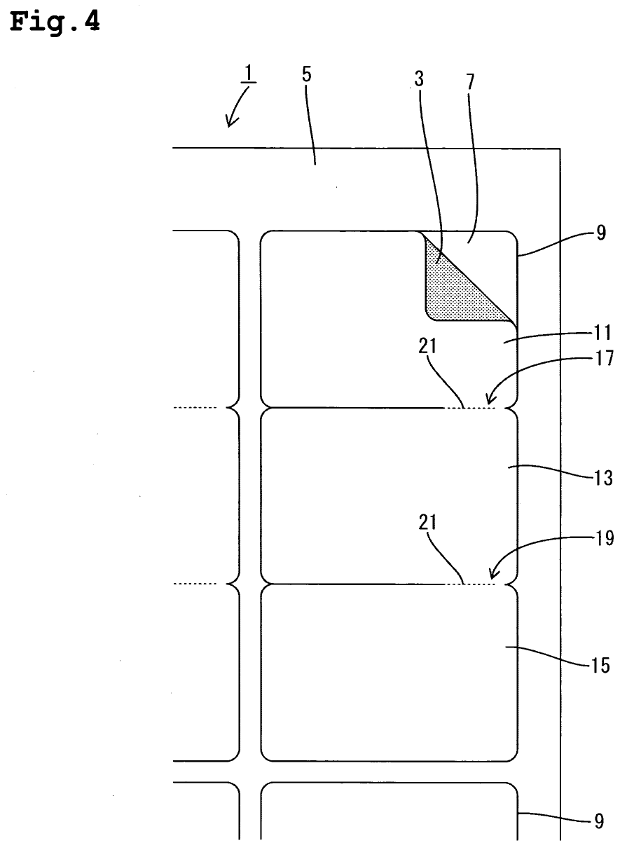

A second embodiment of the present invention will be described next with reference to FIG. 4. The same constructions as in the first embodiment are given the same reference numerals and characters. The explanations of the same structures, operations and effects may be omitted.

In the second embodiment, the lengths of the first connecting portion 17 and the second connecting portion 19 are longer than their lengths in the first embodiment. In addition, perforations 21 are formed in the elongated portions, which is also a point of difference from the first embodiment.

### Third Embodiment

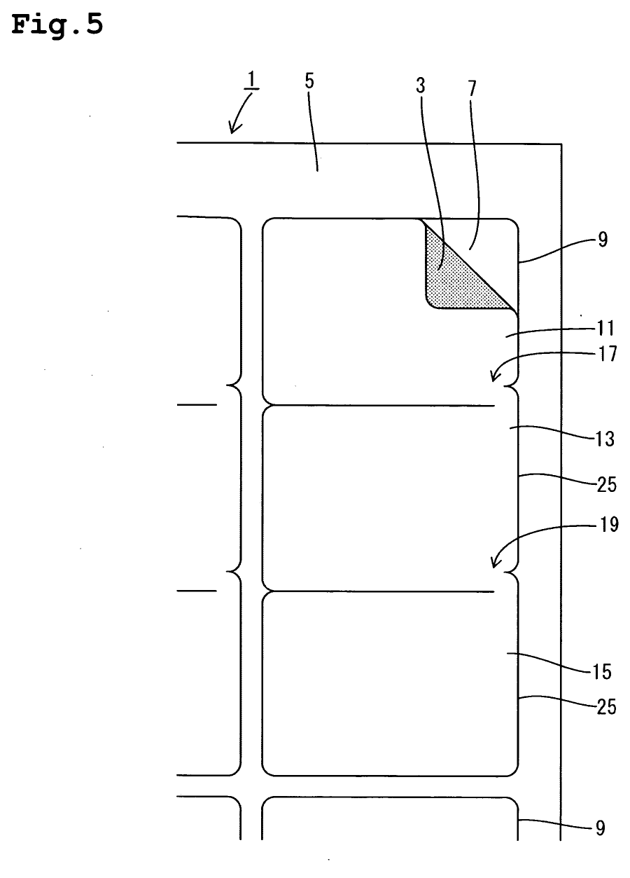

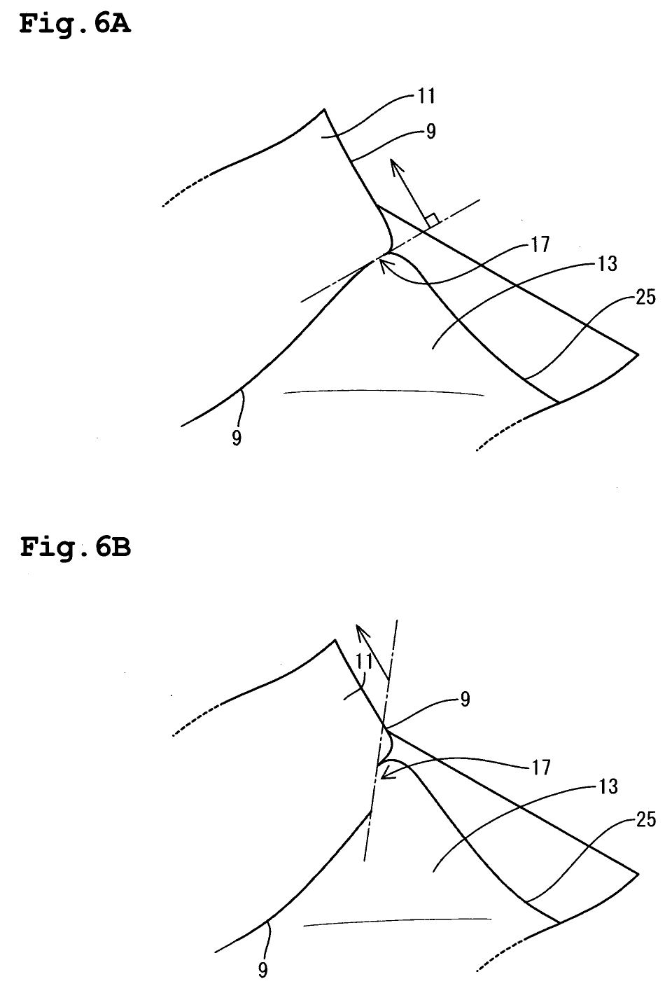

A third embodiment of the present invention will be described next with reference to FIGS. 5 to 6. The same constructions as in the first embodiment are given the same reference numerals and characters, and the explanations of the same structures, operations and effects may be omitted.

In the third embodiment, as shown in FIGS. 5 and 6B, a line connecting the end portions of the cut lines 9, which are located at both sides of the first connecting portion 17, is inclined with respect to a side 25 of the unit label 13. A line connecting the end portions of the cut lines 9, which are located at both sides of the second connecting portion 19, is also inclined with respect to the side 25 of the unit label 15. The inclination of the line connecting the end portions of the cut lines 9 is a point of difference from the first embodiment.

When the line connecting the end portions of the cut lines 9, which end portions are located at both sides of the first connecting portion 17, is orthogonal to the side 25 of the unit label 13, as shown in FIG. 6A, even if the unit label 11 on the upper tier is to be separated from the unit label 13 on the middle tier and the first connecting portion 17 is to be torn apart, the first connecting portion 17 is orthogonal to the direction of the force applied to tear the first connecting portion 17 (see the arrow in FIG. 6A). As a result, the force is not easily transmitted to the first connecting portion 17 and sometimes the first connecting portion 17 is not smoothly separated or torn apart.

According to the construction of this embodiment, the line connecting the end portions of the cut lines 9, which are located at both sides of the first connecting portion 17, is inclined with respect to the side 25 of the unit label 13, as shown in FIG. 6B. Namely, the line is inclined with respect to the direction of the force applied to tear the first connecting portion 17 (see the arrow in FIG. 6B). Therefore, the force is more greatly exerted on the first connecting portion 17 as compared with the case where the line is orthogonal to the force applied to tear it. As a result, the applied force can smoothly separate apart the first connecting portion 17.

### Fourth Embodiment

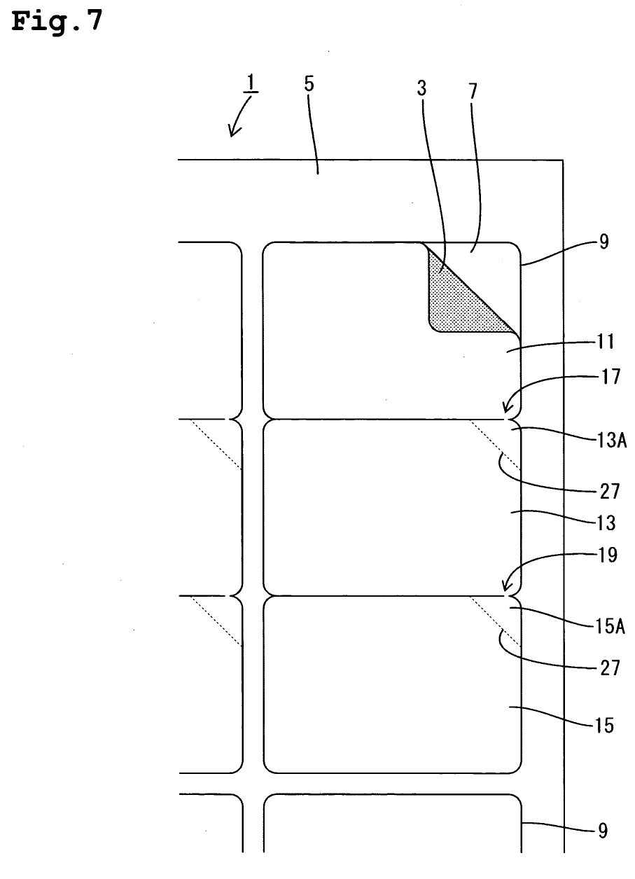

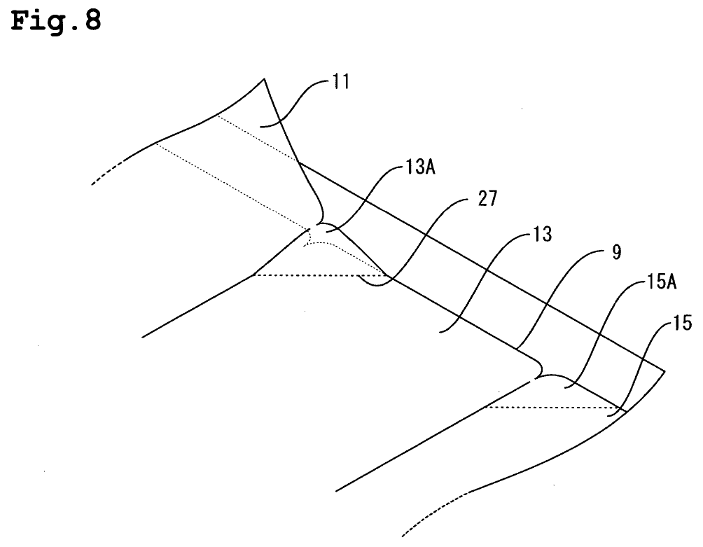

A fourth embodiment of the present invention will be described next with reference to FIGS. 7 to 8. The same constructions as in the first embodiment are given the same reference numerals and characters. The explanations of the same structures, operations and effects may be omitted.

In the fourth embodiment, a linear perforation 27 is formed so as to connect two sides that define the corner portion 13A, where the first connecting portion 17 of the unit label 13 on the middle tier is formed as shown in FIG. 7. In addition, a linear perforation 27 is also formed to connect two sides that define the corner portion 15A where the second connecting portion 19 of the unit label 15 on the lower tier is formed. The linear perforations 27 form fold lines and are points of difference from the first embodiment.

Incidentally, according to the above-described first embodiment, when the unit label 11 on the upper tier is to be peeled from the release sheet 7 in such a manner as to be rolled up from the release sheet 7, the corner portion 13A of the unit label 13 on the middle tier is subsequently placed in a raised state. However, there is the possibility that the corner portion 13A will re-adhere to the release sheet 7 due to the elastic force of the corner portion 13A, even after the corner portion 13A is successfully raised up. This makes it necessary to peel off the corner portion 13A with fingers again when the label 13 on the middle tier is to be peeled off from the release sheet 7, which may be a troublesome operation.

According to the construction and configuration of the fourth embodiment, when the unit label 11 on the upper tier is peeled from the release sheet 7 in such a manner as to be rolled up from the release sheet 7, as shown in FIG. 8, the corner portion 13A of the unit label 13 on the middle tier is also placed into a raised state. In addition, the perforation 27 is folded down, causing a slight crease in the unit label 13. Thereby, the corner portion 13A is held in a raised posture. Accordingly, the unit label 13 on the middle tier can then be reliably kept in a state in which it is easily peeled off. When the unit label 13 on the middle tier is subsequently peeled off, the corner portion 15A of the unit label 15 on the lower tier is similarly held in a raised posture.

### Fifth Embodiment

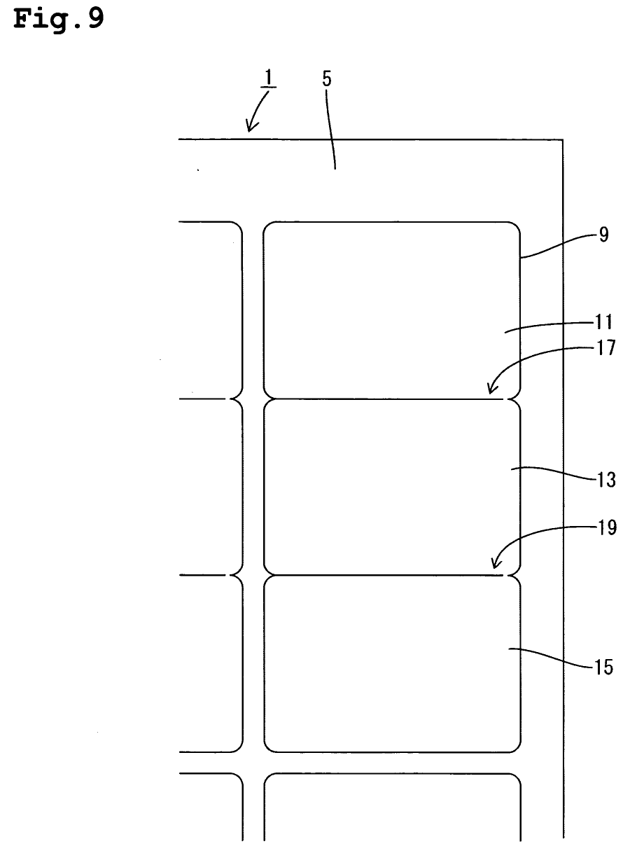

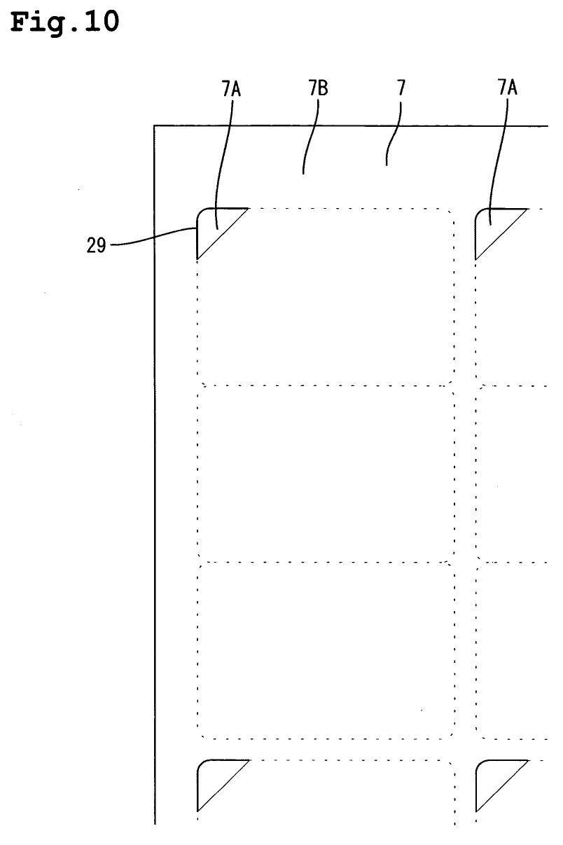

A fifth embodiment of the present invention will be described next with reference to FIGS. 9 to 11. The same constructions as in the first embodiment are given the same reference numerals and characters. The explanations of the similar structures, operations and effects may be omitted. A front surface view of this embodiment is shown in FIG. 9, and a back surface view is shown in FIG. 10.

In the fifth embodiment, a closed loop-shaped slit 29 is used for separating a partial region 7A, which overlaps a region in the vicinity of the corner portion of the unit label 11 on the upper tier, from the other regions 7B of the release sheet 7. The closed loop-shaped slit 29 is formed on the release sheet 7. This closed loop-shaped slit 29 is a point of difference from the first embodiment.

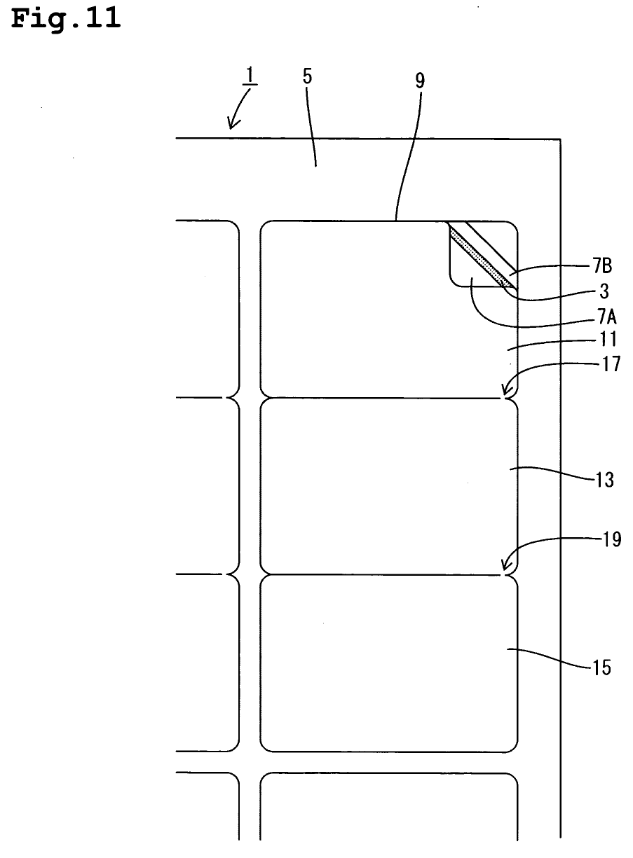

According to the construction of this embodiment, when the partial region 7A of the release sheet 7 is pushed out with fingers toward the side of the information indicating sheet 5 (i.e., the front side of the paper surface) from the side of the release sheet 7 (i.e., the back side of the paper surface), as shown in FIG. 11, the corner portion of the unit label 11 on the upper tier is in a state where the corner portion rises to the front side beyond the surface of the paper. The unit label 11 is then peeled from the release sheet 7 by picking up the corner portion of the unit label 11. Thus, according to the construction of this embodiment, the corner portion of the unit label 11 is easily manipulated.

### Sixth Embodiment

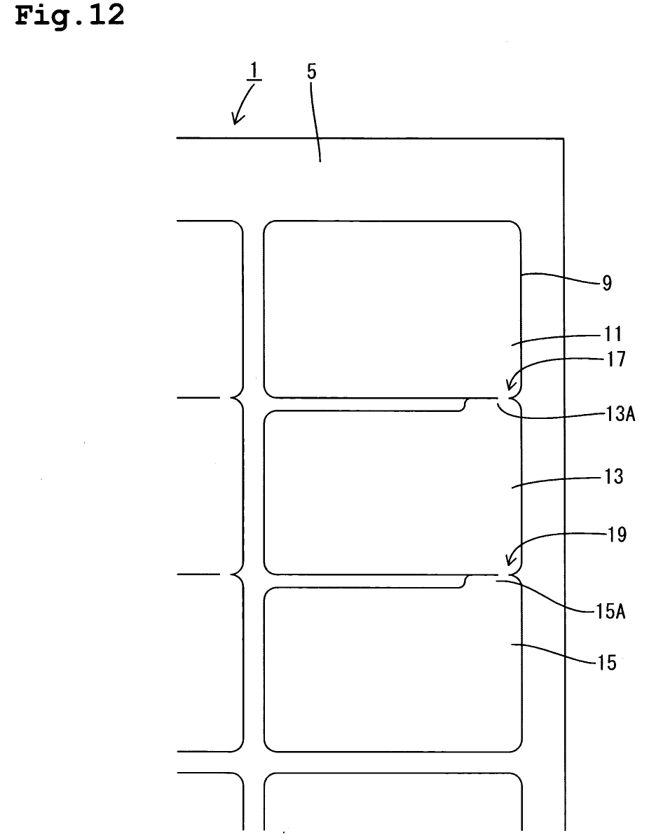

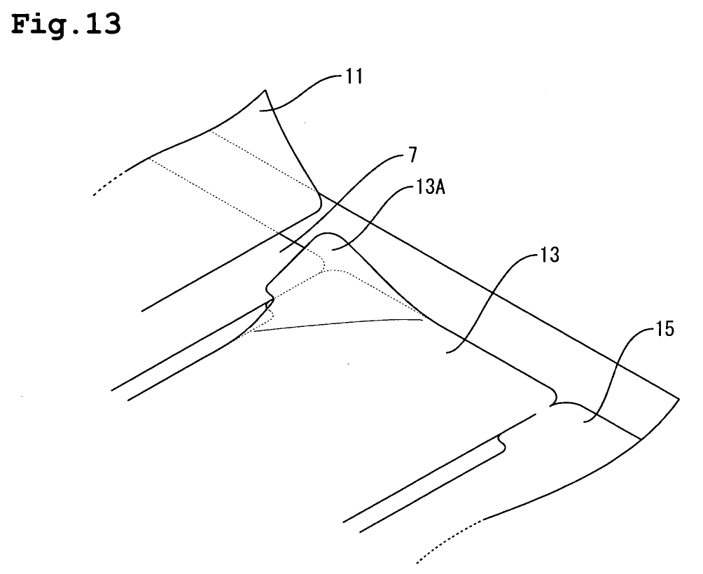

A sixth embodiment of the present invention will be described next with reference to FIGS. 12 to 13. The same constructions as in the first embodiment are given the same reference numerals and characters, and the explanations of the similar structures, operations and effects may be omitted.

In this embodiment, the way of applying the cut line 9 is different from the application used in the first embodiment, as shown in FIG. 12. The cut line 9 is applied so that the corner portion 13A of the unit label 13 on the middle tier, where the first connecting portion 17 is formed, is given the shape of a tab in a form projected from its periphery. The cut line 9 is applied so that the corner portion 15A of the unit label 15 on the lower tier, where the second connecting portion 19 is formed, is also in the shape of a tab in a form projected from its periphery.

According to the construction of this embodiment, when the unit label 11 on the upper tier is peeled from the release sheet 7 in such a manner as to be rolled up from the release sheet 7, the tab-shaped corner portion 13A in the projected form of the unit label 13 in the middle tier (i.e., the adjacent unit label) is brought into a raised state by the first connecting portion 17, as shown in FIG. 13. The corner portion 13A is easier to pick up as compared with a corner portion that is not in the projected form. Therefore, the unit label 13 on the middle tier is easily peeled off from the release sheet 7.

When the unit label 13 on the middle tier is peeled from the release sheet 7 in such a manner as to be rolled up from the release sheet 7, the tab-shaped corner portion 15A in the projected form of the unit label 15 in the lower tier is brought into a raised state by the second connecting portion 19. Therefore, the unit label 15 on the lower tier is also easily peeled off of the release sheet 7.

### Seventh Embodiment

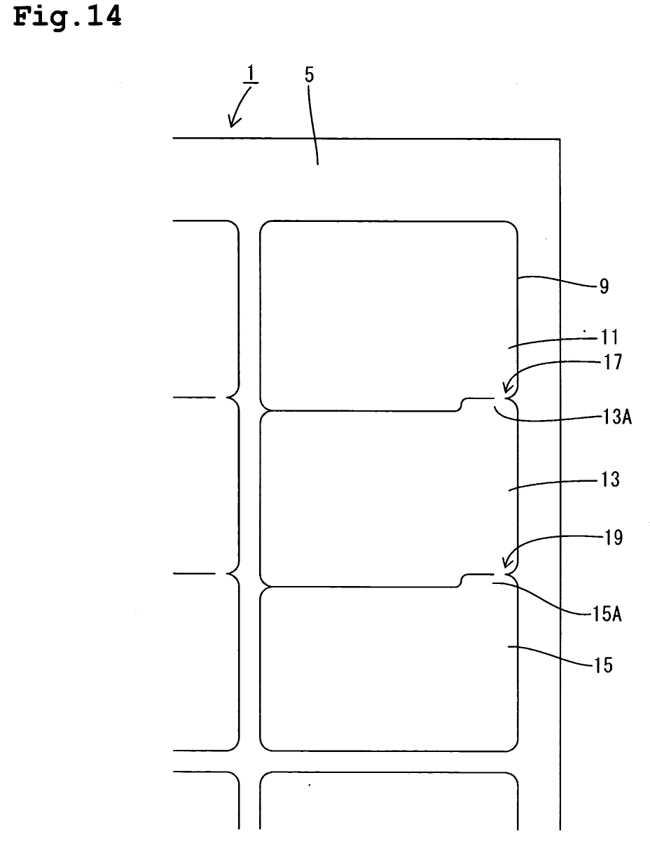

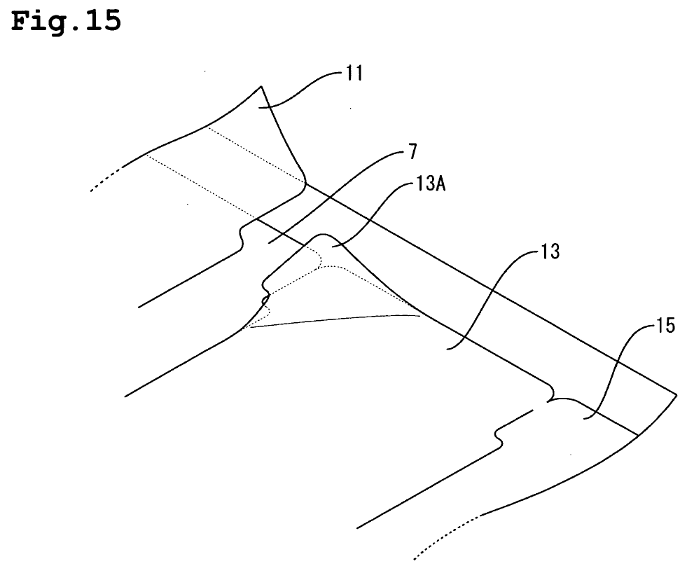

A seventh embodiment of the present invention will be described next with reference to FIGS. 14 to 15. The same constructions as in the sixth embodiment are given the same reference numerals and characters, and the explanations of the similar structures, operations and effects may be omitted.

This embodiment differs from the sixth embodiment in the way of applying the cut line 9, as shown in FIG. 14. However, the seventh embodiment is the same as the sixth embodiment regarding the point that the cut line 9 is applied so that the corner portion 13A of the unit label 13 on the middle tier is in a tab shape in a form projected from its periphery. In addition, the cut line 9 is applied so that the corner portion 15A of the unit label 15 on the lower tier is also in a tab shape in a form projected from its periphery.

The present invention is not to be limited to the embodiments described according to the above descriptions and drawings. By way of illustration, the following embodiments are possible and considered within the scope of the above invention, for example.

(1) In the above-described embodiments, a set of unit labels is shown as constituted by three unit labels 11, 13, and 15. However, a set of unit labels constituted by two unit labels, or a set constituted by four unit labels or more may also be adopted.

(2) A perforation 27 is used in the fourth embodiment as a fold line. However, another form of a fold line, for example, formed by pressing or slight scoring may also be adopted.

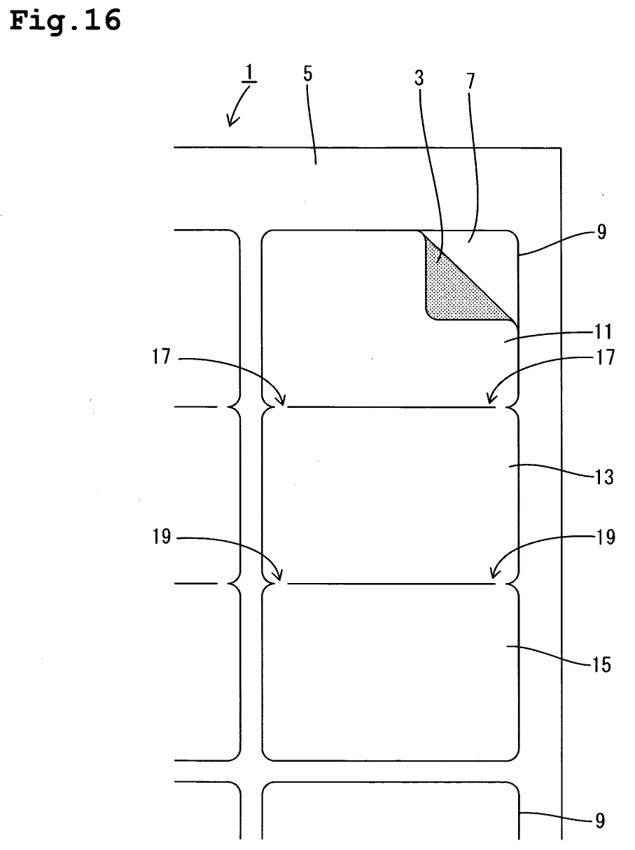

(3) In the above-described embodiments, the unit label 11 on the upper tier is connected to the unit label 13 on the middle tier by the first connecting portion 17 in the vicinity of the lower right corner portion of the unit label 11. In addition, the unit label 13 on the middle tier is connected to the unit label 15 on the lower tier by the second connecting portion 19 in the vicinity of the lower right corner portion of the unit label 13. However, as shown in FIG. 16, the unit label 11 on the upper tier may be connected to the unit label 13 on the middle tier by the first connecting portions 17 in the vicinity of both the lower left and right corner portions. Similarly, the unit label 13 on the middle tier may be connected to the unit label 15 on the lower tier by the second connecting portions 19 in the vicinity of both the lower left and right corner portions.

(4) In the above-described embodiments, the label sheet 1 of a specific size is explained and described. However, the size of the label sheet 1 is not especially limited, and the label sheet 1 may be any convenient size, such as A5, A6, B4, B5, postcard, and the like. In addition, a label sheet 1 in a rectangular shape is used, but the shape of the label sheet is not especially limited.

(5) Connecting portions 17 and 19 are described above using different reference numbers. However, they may have identical configurations.

(6) Rectangular unit labels are described in the above embodiments. However, the shape of a unit label is not especially limited. Different shapes and configurations of unit labels may be used.

This application claims:

1. A label sheet comprising an information indicating sheet including an adhesive layer, and a release sheet that is removably adhered to said adhesive layer, in which the label sheet further comprises the following elements:
at least one cut line formed on said information indicating sheet and defining a plurality of removable unit labels;
said plurality of unit labels being arranged in at least one unit label set comprising at least one combination of adjacent unit labels comprising a first adjacent unit label and a second adjacent unit label, wherein each combination of adjacent unit labels has a common border portion,
a connecting portion formed in the common border portion able to transfer to the second adjacent unit label at least a part of a force of removal applied to the first adjacent unit label and used to remove the first adjacent unit label from the release sheet,
wherein the at least a part of the force of removal raises a portion of the second adjacent unit label of a corresponding at least one combination of adjacent unit labels prior to separating the connection portion.

2. The label sheet as in claim 1, wherein the connecting portion further comprises:
a discontinuation in at least a part of the at least one cut line forming the common border portion.

3. The label sheet as in claim 2, wherein the discontinuation further comprises:
a first end, and
a second end; and
a perforation extending at least partway between the first end and the second end.

4. The label sheet as in claim 3, wherein the release sheet further comprises:
a closed loop-shaped slit surrounding a portion of at least one of the first adjacent unit labels.

5. The label sheet as in claim 4, wherein each of the second adjacent unit labels further comprises:
a fold line located across the portion of the second adjacent unit label raised by the at least a part of the force of removal,
wherein the fold line allows the portion of the second adjacent unit label to remain at least partly raised following the separation of the corresponding connecting portion.

6. The label sheet as in claim 2, wherein the discontinuation further comprises:
a first end, and
a second end; and
wherein a line drawn between the first end and the second end of the connecting portion is inclined with respect to the at least a part of the force of removal transferred to the second adjacent unit label during the removal of the first adjacent unit label.

7. The label sheet as in claim 6, wherein each of the second adjacent unit labels further comprises:
a fold line located across the portion of the second adjacent unit label raised by the at least a part of the force of removal,
wherein the fold line allows the portion of the second adjacent unit label to remain at least partly raised following the separation of the corresponding connecting portion.

8. The label sheet as in claim 1, wherein the release sheet further comprises:
a closed loop-shaped slit surrounding a portion of at least one of the first adjacent unit labels.

9. The label sheet as in claim 1, wherein each of the second adjacent unit labels further comprises:
a fold line located across the portion of the second adjacent unit label raised by the at least a part of the force of removal,
wherein the fold line allows the portion of the second adjacent unit label to remain at least partly raised following the separation of the corresponding connecting portion.

10. The label sheet as in claim 1, wherein the common border portion is formed into a tab shape in a form projected from a periphery of the second adjacent unit label.

11. The label sheet as in claim 1, wherein the connecting portion further comprises:
a first connecting portion, and
a second connecting portion.

12. The label sheet as in claim 1, wherein the connecting portion further comprises:
a plurality of connecting portions.

13. A label sheet comprising an information indicating sheet including an adhesive layer, and a release sheet that is removably adhered to said adhesive layer, in which the label sheet further comprises the following elements:
at least one cut line formed on said information indicating sheet and defining a plurality of removable unit labels;
said plurality of unit labels being arranged in at least one unit label set comprising at least one combination of adjacent unit labels comprising a first adjacent unit label and a second adjacent unit label, wherein each combination of adjacent unit labels has a common border portion,
a connecting portion formed by a discontinuation in the at least one cut line along the common border portion and able to transfer to the second adjacent unit label at least a part of a force of removal applied to the first adjacent unit label and used to remove the first adjacent unit label from the release sheet,
wherein the at least a part of the force of removal raises a portion of the second adjacent unit label of a corresponding at least one combination of adjacent unit labels prior to separating the connection portion.

14. The label sheet as in claim 13, wherein the discontinuation further comprises:
a first end, and
a second end; and
a perforation extending at least partway between the first end and the second end.

15. The label sheet as in claim 13, wherein the release sheet further comprises:
a closed loop-shaped slit surrounding a portion of at least one of the first adjacent unit labels.

16. The label sheet as in claim 13, wherein each of the second adjacent unit labels further comprises:
a fold line located across the portion of the second adjacent unit label raised by the at least a part of the force of removal,
wherein the fold line allows the portion of the second adjacent unit label to remain at least partly raised following the separation of the corresponding connecting portion.

17. The label sheet as in claim 13, wherein the discontinuation further comprises:
a first end, and
a second end; and
wherein a line drawn between the first end and the second end of the connecting portion is inclined with respect to the at least a part of the force of removal transferred to the second adjacent unit label during the removal of the first adjacent unit label.

18. A label sheet comprising an information indicating sheet including an adhesive layer, and a release sheet that is removably adhered to said adhesive layer, in which the label sheet further comprises the following elements:
at least one cut line formed on said information indicating sheet and defining a plurality of substantially rectangular shaped removable unit labels;
said plurality of unit labels being linearly arranged in at least one unit label set comprising at least one combination of adjacent unit labels comprising a first adjacent unit label and a second adjacent unit label, wherein each combination of adjacent unit labels has a common border portion,
a connecting portion formed by a discontinuation in the at least one cut line along the common border portion and able to transfer to the second adjacent unit label at least a part of a force of removal applied to the first adjacent unit label and used to remove the first adjacent unit label from the release sheet,
wherein the at least a part of the force of removal raises a corner portion of the second adjacent unit label of a corresponding at least one combination of adjacent unit labels prior to separating the connection portion.

19. The label sheet as in claim 18, wherein each of the second adjacent unit labels further comprises:
a fold line located across the corner portion of the second adjacent unit label raised by the at least a part of the force of removal,
wherein the fold line allows the corner portion of the second adjacent unit label to remain at least partly raised following the separation of the corresponding connecting portion.

20. The label sheet as in claim 18, wherein the corner portion of the second adjacent unit label is in the form of a tab shape projected from the periphery of the second adjacent unit label.
